(19) United States
(12) Patent Application Publication
(10) Pub. No.: US 2005/0161243 A1
(43) Pub. Date: Jul. 28, 2005

(54) Titanium based containment structures for handheld impact tools

(75) Inventors: Patrick S. Livingston, Easton, PA (US); Edward C. Eardley, Easton, PA (US); Richard J. Bookhout JR., Nazareth, PA (US); Michael J. Loomis, Center Valley, PA (US)

Correspondence Address: MICHAEL BEST & FRIEDRICH, LLP, 100 E WISCONSIN AVENUE, MILWAUKEE, WI, 53202, US

(73) Assignee: Ingersoll-Rand Company, Woodcliff Lake, NJ (US)

(21) Appl. No.: 10/763,370

(22) Filed: Jan. 23, 2004

(51) Int. Cl. B25D 15/00

(52) U.S. Cl. 173/93; 173/171

(57) ABSTRACT

A containment structure for a handheld impact tool and a handheld impact tool incorporating the same including a containment structure that at least partially enshrouds an impact mechanism of the handheld tool, the containment structure including titanium.

Handheld impact tools such as impact wrenches for use in the removal and/or tightening of threaded fasteners, generally include the use of a rotating impact mechanism located within a containment structure. To generate higher torque outputs required, the rotating energy of a given impact mechanism should be as high as possible thereby requiring higher rotational speeds. Such higher rotating energies can cause excess stress in the containment structure if failure of the impact mechanism occurs. As a result, containment structures for such impact tools should be designed to protect the operator against accidental contact with such impact mechanisms, both during normal operation and in the event of a failure condition.

The foregoing illustrates limitations known to exist in present handheld impact tools. Thus it is apparent that it would be advantageous to provide a containment structure and handheld impact tools including the features more fully disclosed hereinafter.

### SUMMARY OF THE INVENTION

According to the present invention, a containment structure for a handheld impact tool and a handheld impact tool incorporating the same are provided in which the containment structure at least partially enshrouds an impact mechanism of the handheld tool and includes titanium.

The foregoing and other aspects will become apparent from the following detailed description of the invention when considered in conjunction with accompanying drawing figures.

### BRIEF DESCRIPTION OF THE DRAWING FIGURES

FIG. 1 is a perspective view of a handheld tool incorporating a titanium based containment structure according to the present invention;

FIG. 2 is a left side view of the handheld tool shown in FIG. 1;

FIG. 3 is a cross-sectional view of the containment structure shown in FIG. 1;

FIG. 4 is a front view of the handheld tool shown in FIG. 1;

FIG. 5 is a rear view of the handheld tool shown in FIG. 1;

FIG. 6 is a top view of the handheld tool shown in FIG. 1; and

FIG. 7 is a bottom view of the handheld tool shown in FIG. 1.

### DETAILED DESCRIPTION OF THE PREFERRED EMBODIMENTS

As used herein, the term “containment structure” means a barrier such as a case or housing that at least partially enshrouds or surrounds an impact mechanism of a handheld tool such as a pneumatic impact wrench. These barriers are employed to provide a barrier against contact by a user with parts, both during normal operation and in the event of a failure of such parts.

The invention is best understood by reference to the accompanying drawings in which like reference numbers refer to like parts. It is emphasized that, according to common practice, the various dimensions of the components shown in the drawings are not to scale and have been enlarged for clarity.

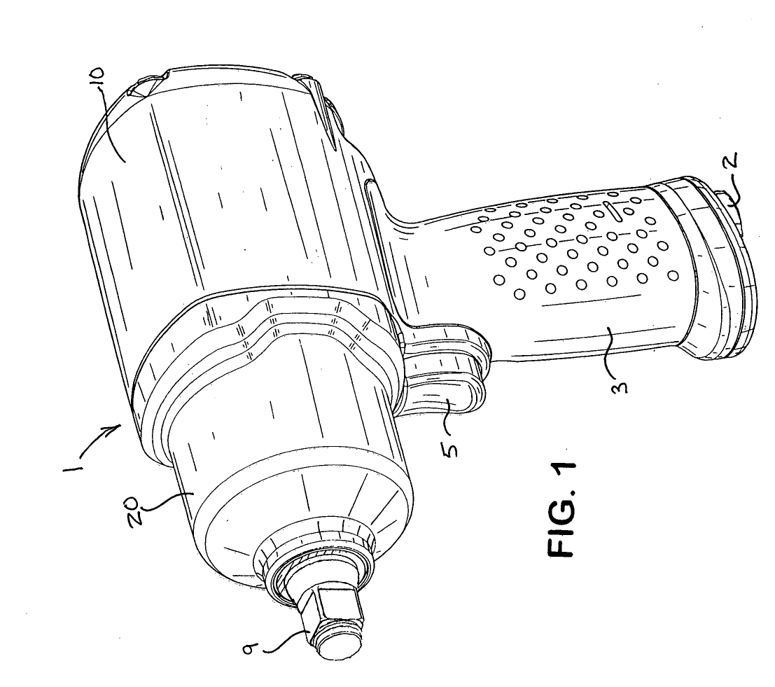

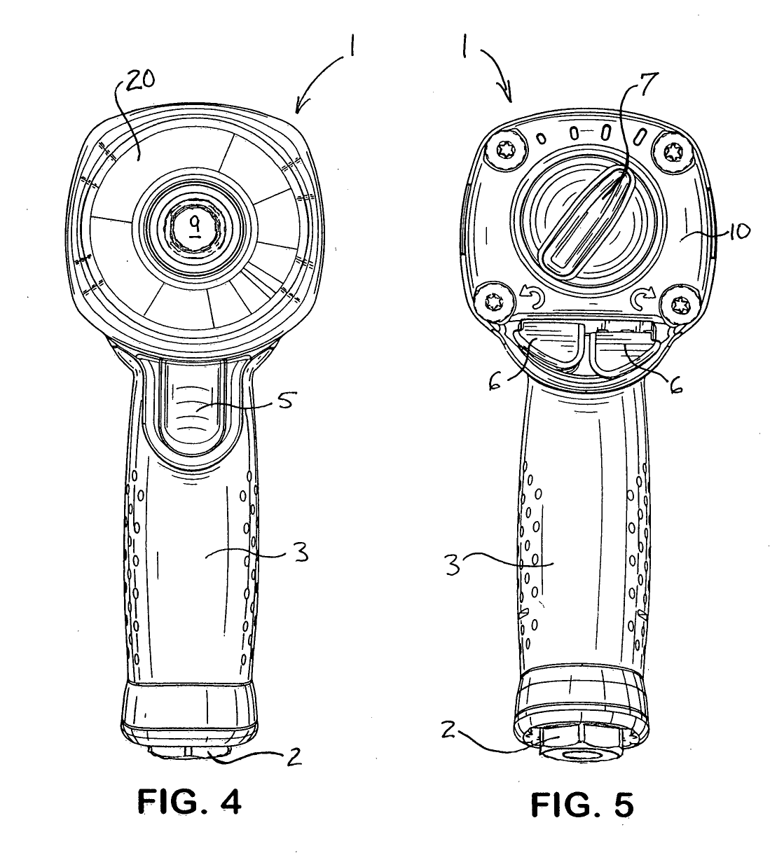

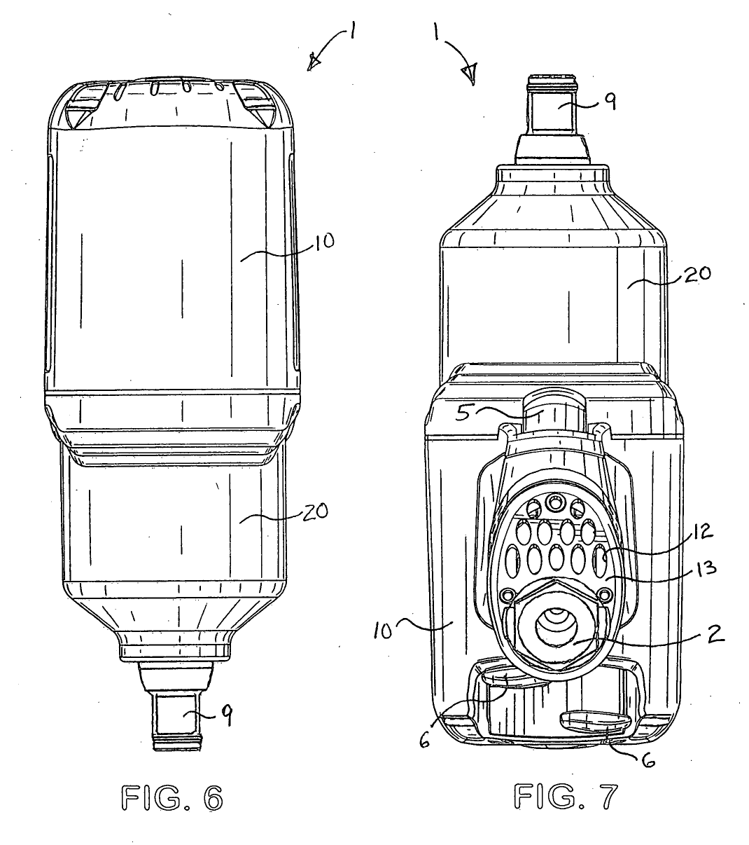

Referring now to the drawings, shown in FIGS. 1, 2, and 4-7 is a handheld tool 1 having a titanium based containment structure according to the present invention. Handheld tool 1 includes a grip handle 3 secured to the under side of a motor housing 10 and at its lower end is provided with a pneumatic fluid or air inlet 2 whereby an air supply hose (not shown) may be connected with the tool. The grip handle 3 and the motor housing 10 may be made of plastic or other composite materials that are preferably lightweight and have suitable mechanical properties. Exemplary materials in this regard are a glass-filled injection molded composite material such as Zytel 84G33 which is a 33% glass reinforced injection molded nylon resin available from DuPont Company, Wilmington, Del.

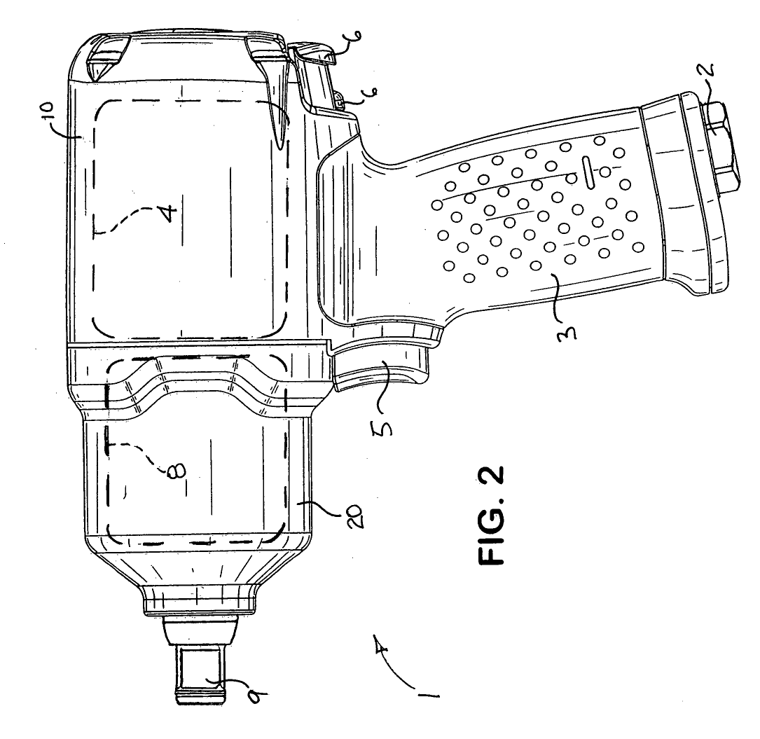

A conventional pneumatic driven rotary type motor or air motor 4 is shown schematically by dashed lines in FIG. 2 which can comprise a plurality of vanes mounted on a rotor may be used to drive the tool 1, to which motive air may be supplied from air inlet 2. The supply of fluid pressure from air inlet 2 to air motor 4 is variably controlled by a finger or trigger piece 5 slidably mounted in the upper forward portion of the handle 3 which actuates a spring biased throttle valve mounted in the handle 3, as is known in the art.

As shown in FIG. 5, a forward/reverse mechanism 6, preferably in the form of pushbuttons, is provided for selectively switching the flow direction of motive fluid to either forward or reverse drive the motor as is known in the art. A power management regulator 7 is also preferably provided to selectively control the power output level of the motor as is known in the art.

Air motor 4 is connected to and rotates a hammer mechanism 8 shown schematically by dashed lines in FIG. 2 disposed in a containment structure 20. Hammer mechanism 8 drives a work output device 9 such as a square drive as shown. Hammer mechanisms useful in the pneumatic tool shown are known in the art and include those disclosed in U.S. Pat. No. 3,661,217 issued to Spencer Maurer, which patent is incorporated herein by reference. Expanded air exhausts from the motor 4 to atmosphere via an exhaust passageway that exits through exhaust vents 12 of a vent cover 13 shown in FIG. 7.

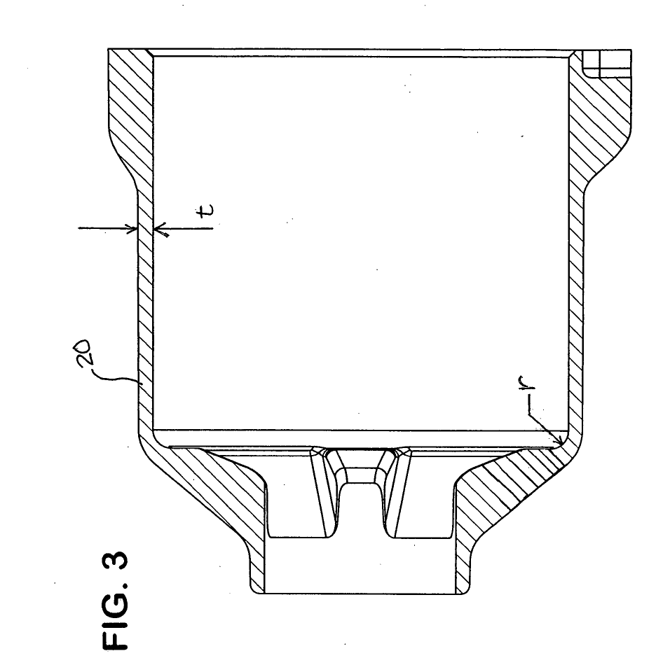

As seen best in FIGS. 2 and 3, containment structure 20 according to the present invention is a barrier that comprises titanium and at least partially enshrouds or surrounds an impact mechanism of a handheld impact tool. Preferably, containment structure 20 is a substantially rigid housing that is arranged coaxially with and extending circumferentially around the axis of rotation of the impact mechanism.

Containment structure 20 is made of a titanium-based material having suitable toughness to contain impact mechanism 8 that may be hurled at high speed and with considerable energy in the event of a mechanical failure. Such materials include titanium-based materials having a yield strength of from about 70 Ksi to about 120 Ksi and an ultimate tensile strength of from about 90 Ksi to about 130 Ksi. Preferably the titanium-based materials are lightweight with a density of 0.16 lbs/in³ or less. Exemplary materials in this regard include titanium based alloys of Ti-6Al-4V, Ti-3Al-2.5V and Ti-4Al-2V in which the addition amounts of aluminum and vanadium are percentages by weight.

The containment structure may be manufactured using methods that facilitate the formation of various wall configurations having combinations of wall thicknesses, t, and shape contour radii, r, to provide exterior and interior shapes having any desired degree of intricacy. Such methods include casting the titanium based material, e.g., by investment casting and, if needed, machining to final form. For machining considerations and to keep overall part cost low, titanium-based alloys are preferred having chemical compositions with aluminum and vanadium spanning between Ti-3Al-2.5V and Ti-4Al-2V that meet the minimum tensile and yield strength properties specified above.

While embodiments and applications of this invention have been shown and described, it will be apparent to those skilled in the art that many more modifications are possible without departing from the inventive concepts herein described. For example, although handheld tool 1 is shown and described as being pneumatically driven, it is to be understood as will be recognized by those skilled in the art that other motive drive mechanisms such as an electric motor may be used in conjunction with the containment structure of the present invention. It is understood, therefore, that the invention is capable of modification and therefore is not to be limited to the precise details set forth. Rather, various modifications may be made in the details within the scope and range of equivalents of the claims without departing from the spirit of the invention.

1. A containment structure for a handheld impact tool comprising:
a containment structure that at least partially enshrouds an impact mechanism of the handheld tool, the containment structure comprising titanium.

2. The containment structure according to claim 1 wherein the containment structure is a substantially rigid housing arranged in operation coaxially with and extending circumferentially around an axis of rotation of the impact mechanism.

3. The containment structure according to claim 1 wherein the containment structure is manufactured by casting.

4. The containment structure according to claim 1 wherein the containment structure is made of a titanium alloy.

5. The containment structure according to claim 4 wherein the titanium alloy is one of Ti-6Al-4V, Ti-3Al-2.5V and Ti-4Al-2V.

6. The containment structure according to claim 4 wherein the titanium alloy has an ultimate tensile strength of from about 90 Ksi to about 130 Ksi and a yield strength of from about 70 Ksi to about 120 Ksi.

7. The containment structure according to claim 4 wherein the titanium alloy has a maximum density of 0.16 lbs/in³.

8. A handheld impact tool comprising:
an impact mechanism having an axis of rotation, and
a containment structure that at least partially enshrouds the impact mechanism, the containment structure comprising titanium.

9. The handheld tool according to claim 8, wherein
the impact mechanism has an axis of rotation, and
the containment structure is a substantially rigid housing arranged coaxially with and extending circumferentially around the axis of rotation of the impact mechanism.

10. The handheld tool according to claim 8 wherein the containment structure is manufactured by casting.

11. The handheld tool according to claim 8 wherein the impact tool is pneumatically driven.

12. The handheld tool according to claim 8 wherein the containment structure is made of a titanium alloy.

13. The handheld tool according to claim 12 wherein the titanium alloy is one of Ti-6Al-4V, Ti-3Al-2.5V and Ti-4Al-2V.

14. The handheld tool according to claim 12 wherein the titanium alloy has an ultimate tensile strength of from about 90 Ksi to about 130 Ksi and a yield strength of from about 70 Ksi to about 120 Ksi.

15. The handheld tool according to claim 12 wherein the titanium alloy has a maximum density of 0.16 lbs/in³.
